(19) United States
(12) Patent Application Publication
(10) Pub. No.: US 2019/0182290 A1
(43) Pub. Date: Jun. 13, 2019

(54) METHOD AND SYSTEM TO RESOLVE A DISTRIBUTED DENIAL OF SERVICE ATTACK THROUGH DENYING RADIO RESOURCE ALLOCATION OF INFECTED END DEVICES

(71) Applicant: Telefonaktiebolaget LM Ericsson (publ), Stockholm (SE)

(72) Inventor: Wassim HADDAD, San Jose, CA (US)

(21) Appl. No.: 16/167,413

(22) Filed: Oct. 22, 2018

Related U.S. Application Data
(60) Provisional application No. 62/596,015, filed on Dec. 7, 2017.

(51) Int. Cl. H04L 29/06; H04W 12/12; H04W 48/02; H04W 24/08; H04W 8/04; H04L 29/12

(52) U.S. Cl. CPC H04L 63/1458; H04W 12/12; H04W 48/02; H04W 84/12; H04W 8/04; H04L 61/6054; H04W 24/08

(57) ABSTRACT

Methods and systems to resolve a distributed denial of service (DDoS) attack in a wireless network are disclosed. In one embodiment, a method comprises receiving signaling messages along with samples of spurious traffic sourced from one or more end devices, where the one or more end devices connect to the wireless network for internet connectivity. The method continues with determining, based the samples, that there is a DDoS attack occurring in which a set of one or more of the end devices is acting as bots in a botnet, and are thus are infected end devices, and causing denial of radio resource allocation to the set of one or more of the infected end devices.

### CROSS-REFERENCE TO RELATED APPLICATIONS

This application claims the benefit of U.S. Provisional Application No. 62/596,015, filed Dec. 7, 2017, which is hereby incorporated by reference.

### TECHNICAL FIELD

Embodiments of the present disclosure relate to the field of wireless communications, and more specifically, relate to a method and system for resolving a distributed denial of service (DDoS) attack through denying radio resource allocation of infected end devices.

### BACKGROUND ART

The “last mile” or “last kilometer” refers to the final leg of the networks that deliver connectivity services to retail end-users (customers). Thus, the last mile may refer to the portion of the telecommunications network chain that physically reaches the end-user's premises (e.g., the copper wire subscriber lines connecting landline telephones to the local telephone exchange; coaxial cable service drops carrying cable television signals from utility poles to subscribers' homes; etc.). The word “mile” is used metaphorically; the length of the last mile link may be more or less than a mile. Because the last mile of a network to the user is conversely the first mile from the user's premises to the outside world when the user is sending data (sending an email, for example), the term first mile is also alternately used.

The radio infrastructure (e.g., using 4G, 5G and beyond) is reaching sufficient speeds to allow operators (e.g., the telecommunications, cable television and internet industries) to provide wireless connectivity over “the last mile.” For example, operators may provide such wireless connectivity by installing lightweight radio-enabled (e.g., 4G, 5G, or beyond) pieces of customer premise equipment (CPE) on customer premises (e.g., homes; small and medium-sized enterprises (SMEs) (also known as small and medium-sized businesses (SMBs)); vehicles; IoT gateways (IoT GWs); etc.).

A denial-of-service attack (DoS attack) is a cyber-attack where the perpetrator seeks to make a machine or network resource unavailable to its intended users by temporarily or indefinitely disrupting services of a host connected to the Internet. Denial of service is typically accomplished by flooding the targeted machine or resource with superfluous requests in an attempt to overload systems and prevent some or all legitimate requests from being fulfilled.

In a distributed denial-of-service attack (DDoS attack), the incoming traffic flooding the victim originates from many different sources. This effectively makes it impossible to stop the attack simply by blocking a single source.

There currently exist certain challenge(s). DDoS attacks are on the rise. In addition to desktops, laptops and servers, Internet of Things (IoT) devices are now being targeted for “botnets conversion.” A botnet includes a number of Internet-connected devices, each of which is running one or more bots. The term “botnet” is a combination of the term “robot” and “network.” Botnets can be used to perform distributed denial-of-service attack (DDoS attack), steal data, send spam, and allow the attacker access to the device and its connection. The owner can control the botnet using command and control (C&C) software.

When leveraging IoT verticals, DDoS attacks can get more devastating due to the high number of IoT devices that can be weaponized resulting in larger botnets. Ready-to-go DDoS kits and online DDoS-as-a-service platforms are making it easier than ever for attackers to get into the DDoS business.

As one notable example, the DDoS attack against a Domain Name System (DNS) provider brought down many other victims. The Domain Name System (DNS) is a hierarchical decentralized naming system for computers, services, or other resources connected to the Internet or a private network. It associates various information with domain names assigned to each of the participating entities. Most prominently, it translates more readily memorized domain names to the numerical IP addresses needed for locating and identifying computer services and devices with the underlying network protocols. The DDoS attack against DNS often cost catastrophic damage to the internet. It's challenging to stop DDoS attacks swiftly.

### SUMMARY

Embodiments of the invention offer efficient ways to stop DDoS attacks through denying radio resource allocation of infected end devices. Embodiments of the invention include methods to resolve a distributed denial of service (DDoS) attack in a wireless network. In one embodiment, a method is performed by an electronic device and includes receiving signaling messages along with samples of spurious traffic sourced from one or more end devices, where the one or more end devices connect to the wireless network for internet connectivity. The method further includes determining, based the samples, that there is a DDoS attack occurring in which a set of one or more of the end devices is acting as bots in a botnet, and are thus are infected end devices, and causing denial of radio resource allocation to the set of one or more of the infected end devices.

Embodiments of the invention include electronic devices to resolve a distributed denial of service (DDoS) attack in a wireless network. In one embodiment, an electronic device to be deployed in the wireless network includes a processor and computer-readable storage medium that provides instructions that, when executed by the processor, cause the electronic device to perform receiving signaling messages along with samples of spurious traffic sourced from one or more end devices, where the one or more end devices connect to the wireless network for internet connectivity. The electronic device further performs determining, based the samples, that there is a DDoS attack occurring in which a set of one or more of the end devices is acting as bots in a botnet, and are thus are infected end devices, and causing denial of radio resource allocation to the set of one or more of the infected end devices.

Embodiments of the invention include computer-readable storage media that provide instructions (e.g., computer program) that, when executed by a processor of an electronic device, cause the electronic device to perform operations comprising one or more methods of the embodiments of the invention.

Through the denial of radio resource allocation to the set of one or more of the end devices, embodiments of the invention “dry” those resources of a botnet that are connecting to the internet over that radio infrastructure (as opposed to further up in the network). The operations are being performed close to the attacker and provide several advantages, including: 1) allowing for early detection; and 2) allowing any mitigating efforts to be applied prior to the network traffic of the attack making it further up into the network. As such, embodiments may save processing cycles, network bandwidth, and storage, as well as the power consumed by such activities, that would have been consumed by the network traffic of the attack.

### BRIEF DESCRIPTION OF THE DRAWINGS

The invention may best be understood by referring to the following description and accompanying drawings that illustrate embodiments of the invention.

FIG. 1 shows a network in which DDoS attacks are resolved through a first set of embodiments.

FIG. 2 shows a network in which DDoS attacks are resolved through a second set of embodiments.

FIG. 3 is a flow diagram showing the operations of resolving a DDoS attack per one embodiment of the invention.

FIG. 4 shows a wireless network per one embodiment of the invention.

FIG. 5A shows an exemplary signal transmission hierarchy in a wireless network.

FIG. 5B shows resource elements used for data and signaling transmission.

FIG. 6 shows a user Equipment per one embodiment of the invention.

FIG. 7 shows a virtualization environment per one embodiment of the invention.

FIG. 8 shows a telecommunication network connected via an intermediate network to a host computer per one embodiment of the invention.

FIG. 9 shows a host computer communicating via a base station with a user equipment over a partially wireless connection per one embodiment of the invention.

### DETAILED DESCRIPTION

The following description describes methods, apparatus, and computer programs to resolve a distributed denial of service (DDoS) attack in a wireless network. In the following description, numerous specific details such as logic implementations, opcodes, means to specify operands, resource partitioning/sharing/duplication implementations, types and interrelationships of system components, and logic partitioning/integration choices are set forth to provide a more thorough understanding of the present invention. One skilled in the art will appreciate, however, that the invention may be practiced without such specific details. In other instances, control structures, gate level circuits and full software instruction sequences have not been shown in detail in order not to obscure the invention. Those of ordinary skill in the art, with the included descriptions, will be able to implement proper functionality without undue experimentation.

Bracketed text and blocks with dashed borders (such as large dashes, small dashes, dot-dash, and dots) may be used to illustrate optional operations that add additional features to the embodiments of the invention. Such notation, however, should not be taken to mean that these are the only options or optional operations, and/or that blocks with solid borders are not optional in some embodiments of the invention.

Terms

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein refers to any positive whole number of items including one item.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radiofrequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to a NIC. One or more parts of an embodiment of the invention may be implemented using different combinations of software, firmware, and/or hardware.

A wireless communication network (or “wireless network,” and the two terms are used interchangeably) is a network of electronic devices communicating using radio waves (electromagnetic waves within the frequencies 30 KHz-300 GHz). The wireless communications may follow wireless communication standards, such as new radio (NR), LTE-Advanced (LTE-A), LTE, wideband code division multiple access (WCDMA), High-Speed Packet Access (HSPA). Furthermore, the communications between the electronic devices such as network devices and terminal devices in the wireless communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. While LTE and NR are used as examples to describe embodiments of the invention, the invention may apply to other wireless communication networks, including LTE operating in unlicensed spectrums, Multefire system, IEEE 802.11 systems. While 4G and/or 5G based systems and their components are used as examples in this disclosure, embodiments of the invention apply to other wireless communication networks as well.

A network device (ND) (also referred to as a network node or node, these terms are used interchangeably in this disclosure) is an electronic device in a wireless communication network via which a terminal device accesses the network and receives services therefrom. One type of network devices may refer to a base station (BS) or an access point (AP), for example, a node B (NodeB or NB), an evolved NodeB (eNodeB or eNB), a next generation node B (gNB), remote radio unit (RRU), a radio header (RH), a remote radio head (RRH), a relay, and a low power node such as a femtocell and a picocell.

A terminal device may access a wireless communication network and receive services from the wireless communication network through a network device. A terminal device may also be referred to as a wireless device (WD), and the two terms are used interchangeably in this disclosure. A terminal device may be a user equipment (UE), which may be a subscriber station (SS), a portable subscriber Station, a mobile station (MS), an access terminal (AT), or other end user devices. An end user device (also referred to as end device, and the two terms are used interchangeably) may be one of a mobile phone, a cellular phone, a smart phone, a tablet, a wearable device, a personal digital assistant (PDA), a portable computer, an image capture terminal device (e.g., a digital camera), a gaming terminal device, a music storage and playback appliance, a vehicle-mounted wireless terminal device, a smart speaker, and an Internet of Things (IoT) device.

End user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. The end user devices may be coupled to the edge NDs directly or through one or more customer premise equipment (CPEs). A CPE is a terminal device located at a subscriber's premises and connected with a network device (ND) of a wireless network and provides Internet access to end user devices. A CPE may also be a residential gateway (RGs), a set-top box, a home networking adapter, an Internet access gateway that connects end user devices (e.g., at a home or an enterprise) to the Internet.

A CPE may communicate with an end user device wirelessly through a local/wide area network (LAN/WAN). The wireless connectivity may be through a short-range wireless technology (e.g., Bluetooth, light-fidelity (Li-Fi), near-field communication (NFC), QR codes/barcodes, radio-frequency identification (RFID), Wi-Fi, Z-Wave, ZigBee), a medium-range wireless technology (Wi-Fi HaLow, LTE), or a long-range wireless technology (e.g., low-power wide-area networking (LPWAN), very small aperture terminal (VSAT).

A CPE may be coupled to the edge NDs through wireline (e.g., cable or various digital subscriber lines (xDSLs)) or wirelessly. When the CPE is able to communicate with the edge NDs wirelessly, the CPE is radio enabled. A radio-enabled CPE may communicate with the edge NDs through a wireless network discussed herein above. A CPE may be virtualized (referred to as “virtualized” CPE) where the majority of its intelligence is moved to the cloud. For example, the intelligence (e.g., network applications and/or services) may be moved to a software-defined network (SDN) controller, or the edge NDs (e.g., a radio base station or a radio cell tower discussed herein. When the CPE is virtualized, the functionalities left at customer premise are limited to connectivity such as configurable bridge to the end devices.

A first Set of Embodiments to Resolve DDoS Attack

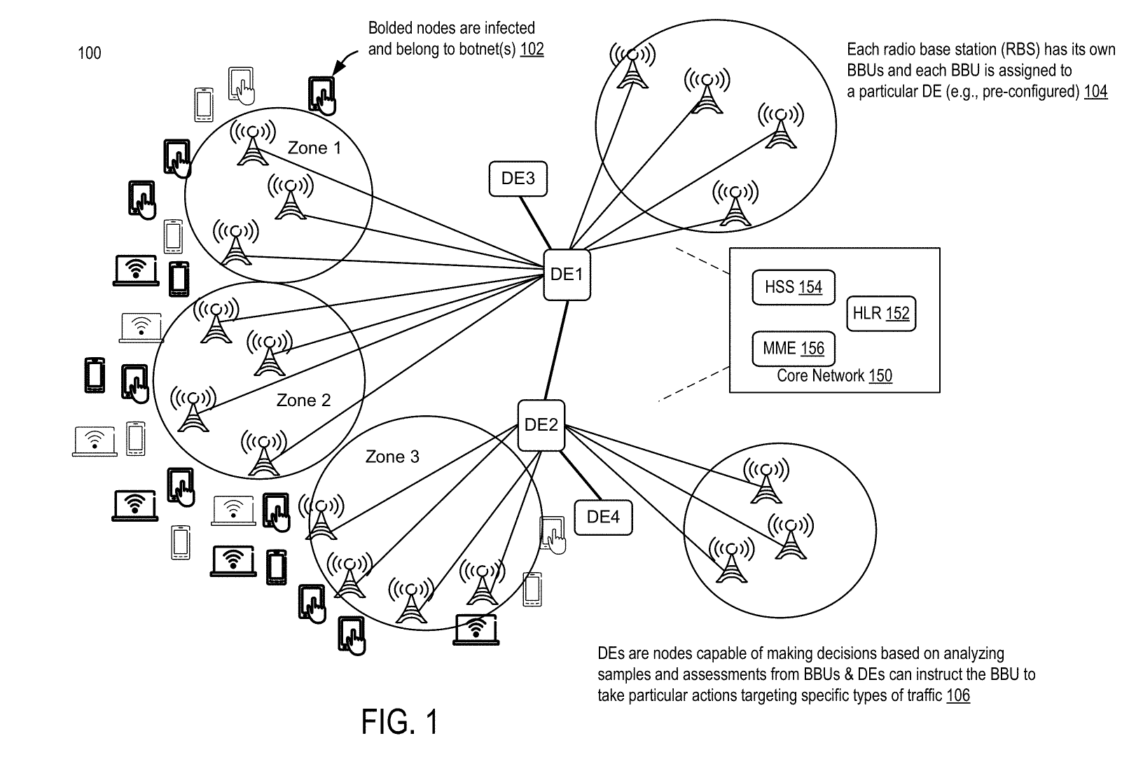

FIG. 1 shows a network in which DDoS attacks are resolved through a first set of embodiments. The network 100 is an exemplary radio infrastructure providing wireless connectivity over “the last mile.” For example, operators may provide such wireless connectivity through installation of radio-enabled (e.g., 4G, 5G, or beyond) customer premise equipment (CPE) on customer premises (e.g., homes; small and medium-sized enterprises (SMEs) (also known as small and medium-sized businesses (SMBs)); vehicles; IoT gateways (IoT GWs); etc.). Different pieces of end devices (illustrated in FIG. 1 using images of various types of computing devices) would connect (wired or wirelessly) to such CPEs (not shown), and the CPEs would connect wirelessly to radio base stations (illustrated in FIG. 1 with images of radio towers and representing the radio infrastructure). In some embodiment, the end devices may connect directly to the radio base stations without going through the CPEs.

A radio base station includes one or more baseband units (BBUs) (also referred to here as the baseband processing circuitry) and one or more remote radio units (RRUs) (also referred to here as remote radio heads (RRHs)). The BBUs and RRUs may be physically separated at different locations.

In some embodiments, operations are performed in the radio infrastructure to “dry” those resources of a botnet that are connecting to the internet over that radio infrastructure. In some particular embodiments, some of these operations are performed in the BBUs of radio base stations within the radio infrastructure. In some embodiment, the operator of the radio base stations may limit access to the BBUs by a network equipment vendor, which may implement an electronic device such as a distributed entity (DE). The distributed entity may be coupled to a BBU and operate to resolve DDoS attacks in one embodiment. As shown at reference 104, each radio base station has its own one or more BBUs and each BBU is assigned to a particular DE (e.g., through pre-configuration or determination during operations) in one embodiment. While in some embodiments DEs are standalone devices and/or are instances run in the cloud, other devices may be used in addition or in the alternative in other embodiments. Additionally or alternatively, the network of DEs can be managed by a third party and can span multiple operators infrastructures.

As illustrated, the DEs can securely coordinate actions and exchange knowledge between each other in some embodiments. In some embodiments, a DE plays a dual role:
“Training system” for the early DDoS detection algorithms running in each BBU. This means that the DE can upgrade the SW running on each BBU whenever new “learning methods” has been made available; and
“Reference” in the sense that it owns the last word, i.e., it is the DE that will decide after listening to assessments from multiple BBUs, looking at samples of traffic and discussing with other DEs that this is indeed a DDoS attack that should be repelled OR “this is not a DDoS attack” OR “more analysis is still needed.”

In FIG. 1, a DDoS attack is being launched from botnets connected to the internet through the radio infrastructure (e.g., connected to a “Mist”). In some embodiments, the below steps are performed to take defensive actions in order to mitigate the botnet's effect. In FIG. 1 a DDoS attack is initiated by having all bold nodes (infected end devices) flood a particular target. In this example, the attack starts from botnet(s) located in Zone 2 and is expected to be followed by botnets located in Zones 1 and 3. Note that botnet's devices (also referred to as the botnet's UEs) include end devices of different sizes ranging from small IoT devices up to laptops/desktops/servers.

Step 1: BBUs located in Zone 2 (e.g., running machine learning on incoming traffic, which includes traffic from the infected end devices) detect spurious activities and proceed to store specific parameters identifying infected end devices. In some embodiments, these parameters may range from radio layers identification parameters up to IP addresses, as well as correlations of these parameters. The incoming traffic may come directly from the end devices or it may come through the radio-enabled CPE.

In some embodiments, the BBUs may consult with a home location register (HLR) database 152 to gather more data about infected end devices. An HLR is a central database that contains details of each mobile phone subscriber that is authorized to use a core network such as the core network 150.

Step 2: Each BBU that detects such spurious activity sends a signaling message (e.g., using a protocol, such as Constrained Application Protocol (CoAP) (a web transfer protocol for use with constrained nodes and constrained networks in the Internet of Things (RFC 7252 Constrained Application Protocol), Quick UDP Internet Connections (QUIC) (a transport layer network protocol that supports a set of multiplexed connections between two endpoints over User Datagram Protocol (UDP)), or HTTP using addition signaling messages) to its currently assigned DE along with a sample of the spurious traffic (e.g., packet header) and waits for recommendation. Additionally or alternatively, the signaling message may include parameters identifying the traffic, e.g., type of traffic, number of packets received, etc.

Step 3: Responsive to receiving enough samples, a DE runs further analytics, draws a conclusion, and takes actions by responding to the senders. In some embodiments, a DE may also communicate with other DEs to strengthen a particular decision and/or alert other DEs about incoming attack so they can request actions from the BBUs assigned to them.

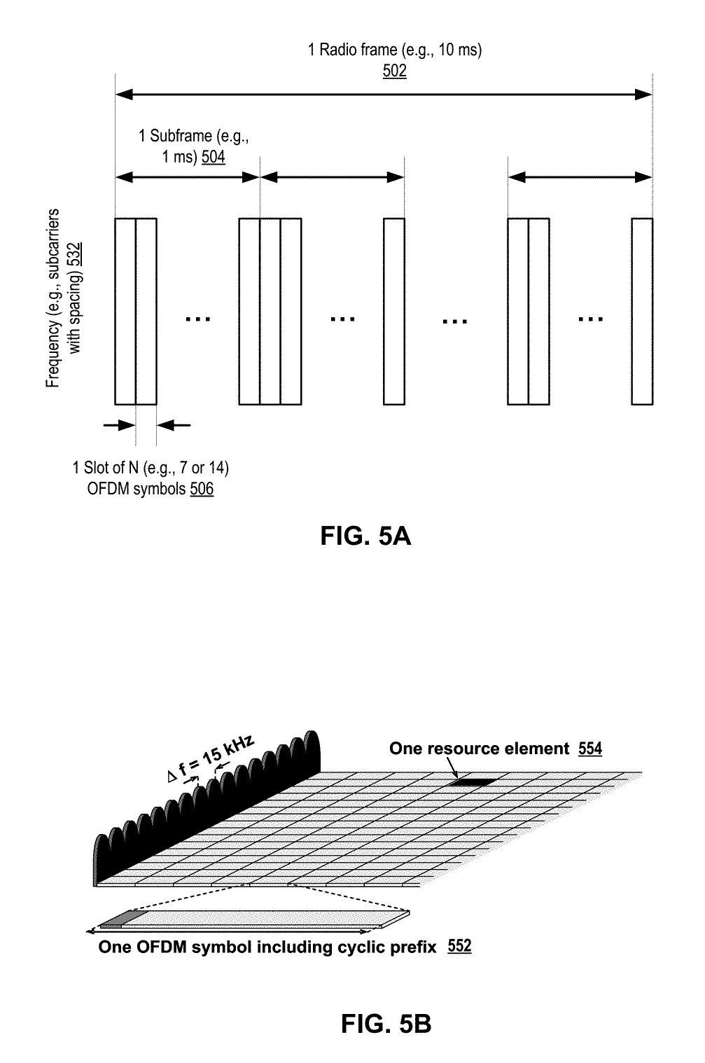

When a DE confirms an attack, BBUs are requested to deny allocating radio resources (also referred to as over-the-air resources and the two terms are used interchangeably) to infected end devices thus, putting them practically out of action. The BBUs may instruct the radio-enabled CPE not to allocate any radio resources to the infected end devices. In alternative, when the infected end devices connect to the BBUs directly without going through the CPE or the CPE is virtualized so that the intelligence of the CPE is moved to the BBUs, the BBUs may stop allocating radio resources to the infected end devices. Alternatively, the DE may instruct the radio-enabled CPE not to allocate any radio resources to the infected end devices. The infected end device may be denied of allocation of resource elements (REs) in one embodiment. The radio resources are discussed in further details herein below relating to FIGS. 5A-B.

In some embodiments, in parallel with communicating with the BBUs, a DE may also trigger further action(s), e.g., by requesting HSS 154 and/or MME 156 to take further actions to deny access to infected end devices. HSS refers to a Home Subscriber Server, which is a central database that contains user-related and subscription-related information. The functions of the HSS include functionalities such as mobility management, call and session establishment support, user authentication and access authorization. The HSS is based on pre-Rel-4 Home Location Register (HLR) and Authentication Center (AuC). MME refers to a Mobility Management Entity, which is a control-node for an access network (e.g., the LTE access-network). MME is responsible for idle mode UE (User Equipment) paging and tagging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user (by interacting with the HSS). The Non-Access Stratum (NAS) signaling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signaling and handles the security key management.

When a DE determines there is not an attack, the DE would instruct BBUs to take no action against the spurious traffic. In some embodiments, the DE deciding on and taking this action may be shared with other DEs including those which are not (yet) aware of any such traffic.

When a DE determines that more analytics are needed, the DE can instruct BBUs to redirect spurious traffic to the DE so that the DE may perform more analysis.

While DE1-DE4 are shown at reference 106 as the entity to make decisions about DDoS attacks, the decisions may be made by corresponding BBUs or RRHs. For example, the radio enabled CPEs may detect spurious activities and proceed to store specific parameters identifying infected end devices at Step 1 above. Then a radio enabled CPE that detects such spurious activity sends the samples and signaling message to a BBU (or RRH) at Step 2. Then the BBU or a corresponding RRH may run further analytics, draws a conclusion, and takes actions by responding to the senders. The BBU/RRH may also coordinate with HSS and/or MME as well. The advantage of using BBU/RRH to make the DDoS attack include moving the decision-making closer to the end devices thus may save more radio resources.

Through the set of embodiments, the operations are performed in the radio infrastructure to “dry” those resources of a botnet that are connecting to the internet over that radio infrastructure (as opposed to further up in the network), and that means the operations are being performed close to the attacker. This provides several advantages, including: 1) allowing for early detection; and 2) allowing any mitigating efforts to be applied prior to the network traffic of the attack making it further up into the network. As such, embodiments may save processing cycles, network bandwidth, and storage, as well as the power consumed by such activities, that would have been consumed by the network traffic of the attack.

A Second Set of Embodiments to Resolve DDoS Attack

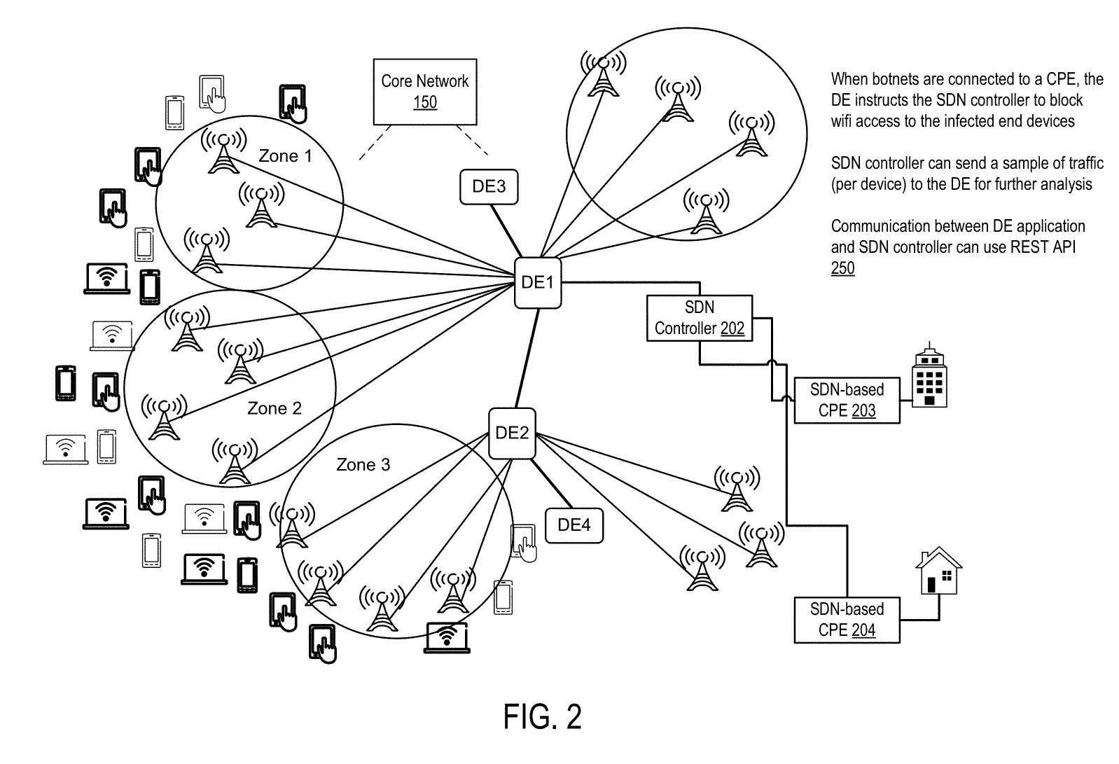

FIG. 2 shows a network in which DDoS attacks are resolved through a second set of embodiments. As illustrated in FIG. 2, in some embodiments there is a connection between a DE and an SDN controller (e.g., using, for example, a Representational state transfer (REST) application programming interface (API) (also known as a RESTful API). In some embodiments, this may be employed in conjunctions the use of the virtual CPE (e.g., a CPE at the customer premise has minimal intelligence and is controlled by the SDN controller). The SDN controllers are coupled to radio-enabled CPEs at the customer premises (e.g., home or enterprise). These CPEs are referred to as SDN-based CPEs 203-204.

In some attacks, it may be that only some UEs within a customer premise (e.g., home or enterprise) get weaponized (infected and used by the botnet), and some embodiments identify and block only the weaponized devices instead of shutting off the CPE itself. In this case, the DE can instruct the SDN controller to retrieve one or more samples of the traffic being sent by each device connected through the CPE in order to identify the infected end device(s) and block it at the access point level (e.g., blocking the WiFi access applying MAC filtering). This is shown in FIG. 2 by a line from DE1 to the SDN controller, and lines from the SDN controller to SDN based radio-enabled CPEs. The operations in one embodiment are shown at reference 250. In one embodiment, the blocking of the infected end devices may be based on information from the HLR 152, HSS154 and/or MME 156 of core network 150, similar to the first set of embodiments.

Operations of Resolving DDoS Attack in Accordance with Some Embodiments

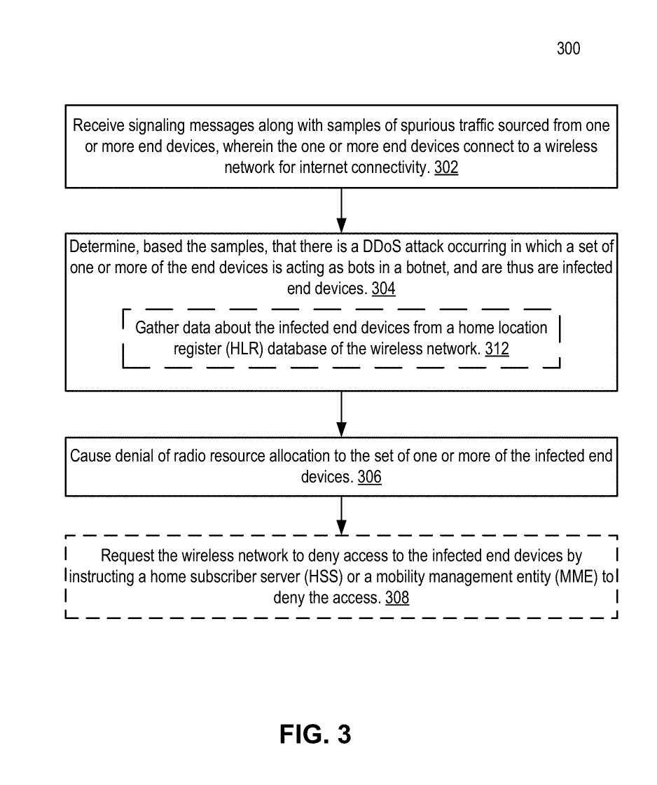

FIG. 3 is a flow diagram showing the operations of resolving a DDoS attack per one embodiment of the invention. Method 300 is performed by an electronic device. The electronic device is a distributed entity that is coupled to one or more baseband units (BBUs) of a wireless network. The BBUs are a part of a radio base station that may also include a remote radio head.

At reference 302, the electronic device receives signaling messages along with samples of spurious traffic sourced from one or more end devices. The one or more end devices connect to the wireless network. The one or more end devices may be coupled to the one or more BBUs for internet connectivity in one embodiment. The one or more end devices may connect to a radio-enabled customer premise equipment (CPE) for internet connectivity in one embodiment, where the CPE is coupled to the one or more BBUs. The signaling messages and the samples are received from BBUs in one embodiment. Additionally or alternatively, the signaling messages and the samples are received from the radio-enabled CPE to which the end devices are connected. In one embodiment, the signaling messages include parameters identifying one or more of the type of traffic and the number of packets received. In one embodiment, the samples are packet headers.

The BBUs and/or the radio-enabled CPEs may store identification information of the end devices from which the samples are received. The identification information of the end devices comprises one or more of a mobile station international subscriber directory number (MSISDN), a temporary MSISDN (TMSISDN), an International mobile subscriber identity (IMSI), an internet protocol (IP) address, a port number, or a media access control (MAC address) in one embodiment.

At reference 304, the electronic device determines, based the samples, that there is a DDoS attack occurring in which a set of one or more of the end devices is acting as bots in a botnet, and are thus are infected end devices. In one embodiment, the electronic device gathers data about the infected end devices from a home location register (HLR) database of the wireless network at reference 312 when determines the existence of the DDoS attack.

At reference 306, the electronic device causes denial of radio resource allocation to the set of one or more of the infected end devices. In one embodiment, causing the denial of radio resource allocation to the set of one or more of the infected end devices comprises instructing the radio base station to deny the radio resource allocation to the set of one or more of the infected end devices. In one embodiment, the radio base station stops allocating radio resources to the infected end devices. In another embodiment, the radio base station causes the radio enabled CPEs not to allocate radio resources to the infected end devices.

At reference 308, the electronic device optionally requests the wireless network to deny access to the infected end devices by instructing a home subscriber server (HSS) or a mobility management entity (MME) to deny the access.

In one embodiment, the radio-enabled CPE connects to a software-defined network (SDN) controller, which is coupled to the distributed entity. The distributed entity receives the signaling messages along with the samples of the spurious traffic from the SDN controller and performs the determination of the DDoS attack. The distributed entity then may cause denial of radio resource allocation to the set of one or more of the infected end devices. In one embodiment, the radio-enabled CPE blocks radio resource allocation only to the set of infected end devices and the other end devices coupled to the radio-enabled CPE and the radio-enabled CPE remain operational.

In one embodiment, the baseband unit (BBU) and/or a remote radio head (RRH) may be the electronic device performing method 300. In that case, the BBU/RRH receives signaling messages along with samples of spurious traffic from one or more radio-enabled CPE at reference 302. At reference 304, the BBU/RRH determines that the DDoS attack is occurring, and the BBU/RRH causes denial of radio resource allocation to the set of one or more of the infected end devices at reference 306.

A Wireless Network in Accordance with Some Embodiments.

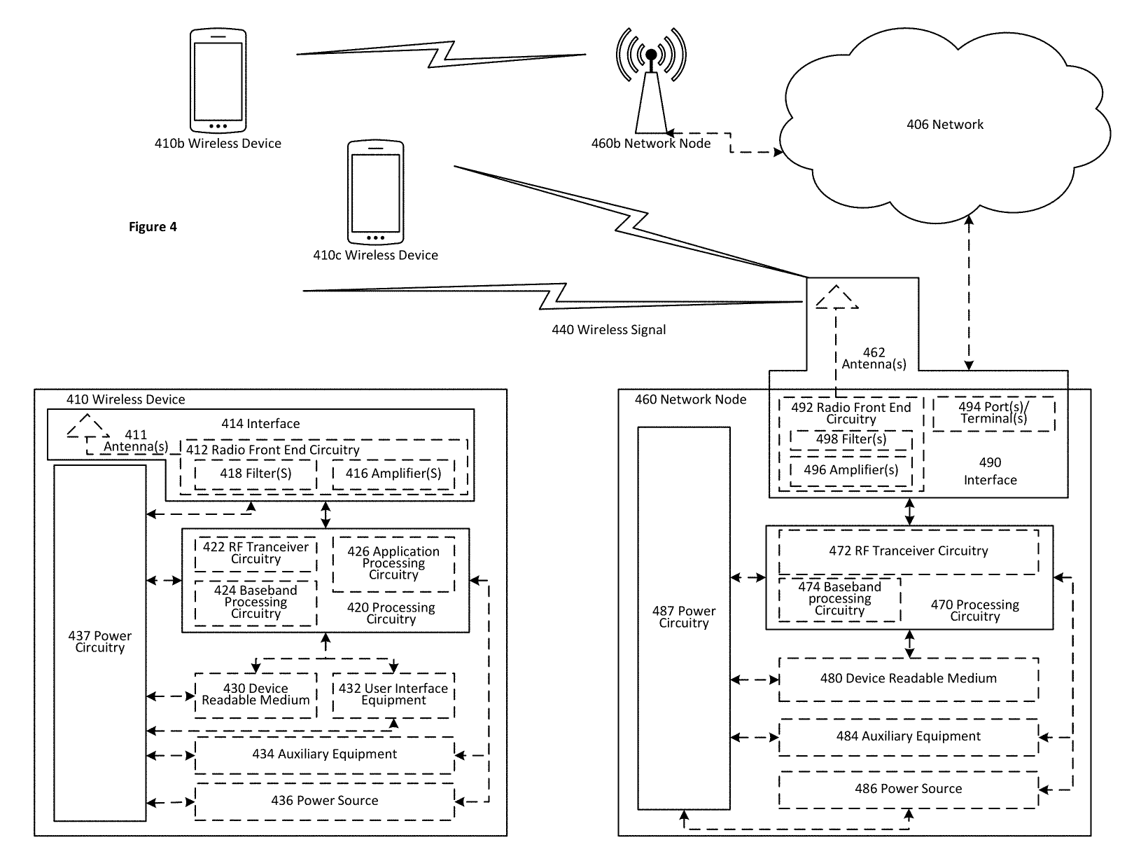

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 406, network nodes 461 and 460b, and WDs 410, 410b, and 410c. In practice, a wireless network may further include any additional elements suitable to support communication between wireless devices or between a wireless device and another communication device, such as a landline telephone, a service provider, or any other network node or end device. Of the illustrated components, network node 460 and wireless device (WD) 410 are depicted with additional detail. The wireless network may provide communication and other types of services to one or more wireless devices to facilitate the wireless devices' access to and/or use of the services provided by, or via, the wireless network.

The wireless network 406 may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 460 and WD 410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

Network node 460 and WD 410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node, similar to network device discussed herein above, refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay.

A network node may also include one or more (or all) parts of a distributed radio base station such as centralized digital units and/or remote radio units (RRUs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

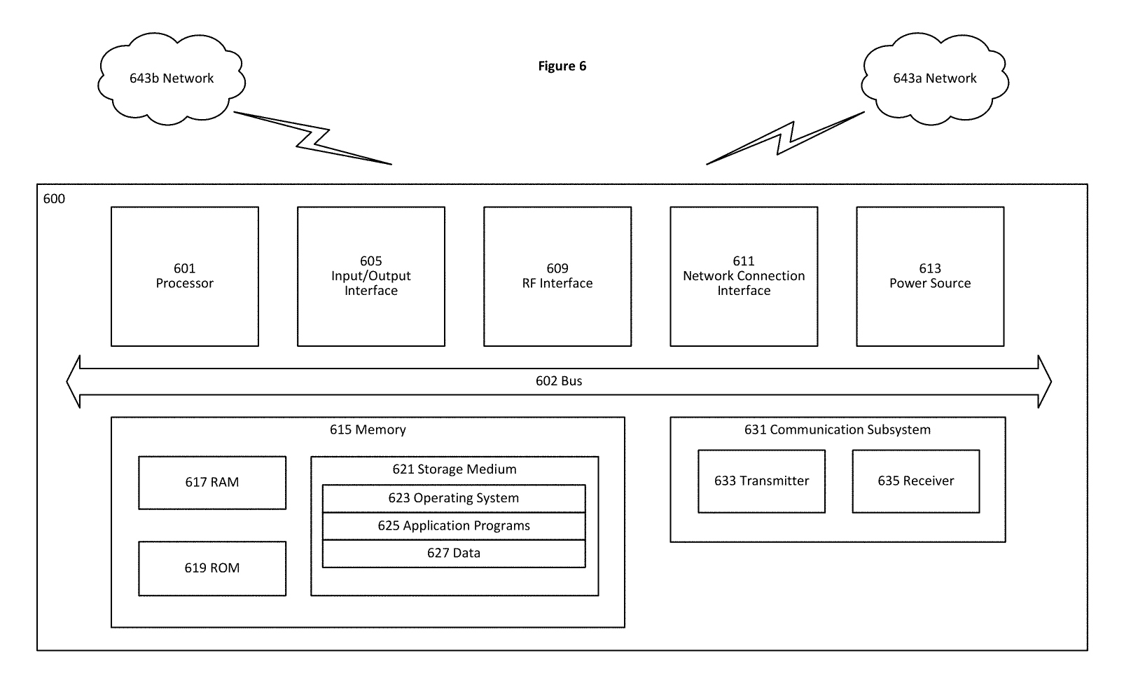

In FIG. 4, network node 460 includes processing circuitry 470, device readable medium 480, interface 490, auxiliary equipment 484, power source 486, power circuitry 487, and antenna 462. Although network node 460 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 460 are depicted as single boxes located within a larger box, or nested within multiple boxes, in practice, a network node may comprise multiple different physical components that make up a single illustrated component (e.g., device readable medium 480 may comprise multiple separate hard drives as well as multiple RAM modules).

Similarly, network node 460 may be composed of multiple physically separate components (e.g., a NodeB component and a RNC component, or a BTS component and a BSC component, etc.), which may each have their own respective components. In certain scenarios in which network node 460 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 460 may be configured to support multiple radio access technologies (RATs). In such embodiments, some components may be duplicated (e.g., separate device readable medium 480 for the different RATs) and some components may be reused (e.g., the same antenna 462 may be shared by the RATs). Network node 460 may also include multiple sets of the various illustrated components for different wireless technologies integrated into network node 460, such as, for example, GSM, WCDMA, LTE, NR, WiFi, or Bluetooth wireless technologies. These wireless technologies may be integrated into the same or different chip or set of chips and other components within network node 460.

Processing circuitry 470 is configured to perform any determining, calculating, or similar operations (e.g., certain obtaining operations) described herein as being provided by a network node. These operations performed by processing circuitry 470 may include processing information obtained by processing circuitry 470 by, for example, converting the obtained information into other information, comparing the obtained information or converted information to information stored in the network node, and/or performing one or more operations based on the obtained information or converted information, and as a result of said processing making a determination.

Processing circuitry 470 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 460 components, such as device readable medium 480, network node 460 functionality. For example, processing circuitry 470 may execute instructions stored in device readable medium 480 or in memory within processing circuitry 470. Such functionality may include providing any of the various wireless features, functions, or benefits discussed herein. In some embodiments, processing circuitry 470 may include a system on a chip (SoC).

In some embodiments, processing circuitry 470 may include one or more of radio frequency (RF) transceiver circuitry 472 and baseband processing circuitry 474. In some embodiments, radio frequency (RF) transceiver circuitry 472 and baseband processing circuitry 674 may be on separate chips (or sets of chips), boards, or units, such as radio units and digital units. In alternative embodiments, part or all of RF transceiver circuitry 472 and baseband processing circuitry 474 may be on the same chip or set of chips, boards, or units.

In certain embodiments, some or all of the functionality described herein as being provided by a network node, base station, eNB or other such network device may be performed by processing circuitry 470 executing instructions stored on device readable medium 480 or memory within processing circuitry 470. In alternative embodiments, some or all of the functionality may be provided by processing circuitry 470 without executing instructions stored on a separate or discrete device readable medium, such as in a hard-wired manner In any of those embodiments, whether executing instructions stored on a device readable storage medium or not, processing circuitry 470 can be configured to perform the described functionality. The benefits provided by such functionality are not limited to processing circuitry 470 alone or to other components of network node 460, but are enjoyed by network node 460 as a whole, and/or by end users and the wireless network generally.

Device readable medium 480 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 470. Device readable medium 480 may store any suitable instructions, data or information, including a computer program, software, an application including one or more of logic, rules, code, tables, etc. and/or other instructions capable of being executed by processing circuitry 470 and, utilized by network node 460. Device readable medium 480 may be used to store any calculations made by processing circuitry 470 and/or any data received via interface 490. In some embodiments, processing circuitry 470 and device readable medium 480 may be considered to be integrated.

Interface 490 is used in the wired or wireless communication of signaling and/or data between network node 460, network 606, and/or WDs 410. As illustrated, interface 490 comprises port(s)/terminal(s) 494 to send and receive data, for example to and from network 606 over a wired connection. Interface 490 also includes radio front end circuitry 492 that may be coupled to, or in certain embodiments a part of, antenna 462. Radio front end circuitry 492 comprises filters 498 and amplifiers 496. Radio front end circuitry 492 may be connected to antenna 462 and processing circuitry 470. Radio front end circuitry may be configured to condition signals communicated between antenna 462 and processing circuitry 470. Radio front end circuitry 492 may receive digital data that is to be sent out to other network nodes or WDs via a wireless connection. Radio front end circuitry 492 may convert the digital data into a radio signal having the appropriate channel and bandwidth parameters using a combination of filters 498 and/or amplifiers 496. The radio signal may then be transmitted via antenna 462. Similarly, when receiving data, antenna 462 may collect radio signals which are then converted into digital data by radio front end circuitry 492. The digital data may be passed to processing circuitry 470. In other embodiments, the interface may comprise different components and/or different combinations of components.

In certain alternative embodiments, network node 460 may not include separate radio front end circuitry 492, instead, processing circuitry 470 may comprise radio front end circuitry and may be connected to antenna 462 without separate radio front end circuitry 492. Similarly, in some embodiments, all or some of RF transceiver circuitry 472 may be considered a part of interface 490. In still other embodiments, interface 490 may include one or more ports or terminals 694, radio front end circuitry 492, and RF transceiver circuitry 472, as part of a radio unit (not shown), and interface 490 may communicate with baseband processing circuitry 474, which is part of a digital unit (not shown).

Antenna 462 may include one or more antennas, or antenna arrays, configured to send and/or receive wireless signals. Antenna 462 may be coupled to radio front end circuitry 492 and may be any type of antenna capable of transmitting and receiving data and/or signals wirelessly. In some embodiments, antenna 462 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 462 may be separate from network node 460 and may be connectable to network node 460 through an interface or port.

Antenna 462, interface 490, and/or processing circuitry 470 may be configured to perform any receiving operations and/or certain obtaining operations described herein as being performed by a network node. Any information, data and/or signals may be received from a wireless device, another network node and/or any other network equipment. Similarly, antenna 462, interface 490, and/or processing circuitry 470 may be configured to perform any transmitting operations described herein as being performed by a network node. Any information, data and/or signals may be transmitted to a wireless device, another network node and/or any other network equipment.

Power circuitry 487 may comprise, or be coupled to, power management circuitry and is configured to supply the components of network node 460 with power for performing the functionality described herein. Power circuitry 487 may receive power from power source 686. Power source 686 and/or power circuitry 487 may be configured to provide power to the various components of network node 460 in a form suitable for the respective components (e.g., at a voltage and current level needed for each respective component). Power source 686 may either be included in, or external to, power circuitry 487 and/or network node 460. For example, network node 460 may be connectable to an external power source (e.g., an electricity outlet) via an input circuitry or interface such as an electrical cable, whereby the external power source supplies power to power circuitry 487. As a further example, power source 686 may comprise a source of power in the form of a battery or battery pack which is connected to, or integrated in, power circuitry 487. The battery may provide backup power should the external power source fail. Other types of power sources, such as photovoltaic devices, may also be used.

Alternative embodiments of network node 460 may include additional components beyond those shown in FIG. 4 that may be responsible for providing certain aspects of the network node's functionality, including any of the functionality described herein and/or any functionality necessary to support the subject matter described herein. For example, network node 460 may include user interface equipment to allow input of information into network node 460 and to allow output of information from network node 460. This may allow a user to perform diagnostic, maintenance, repair, and other administrative functions for network node 460.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 410 includes antenna 411, interface 414, processing circuitry 420, device readable medium 430, user interface equipment 432, auxiliary equipment 434, power source 436 and power circuitry 437. WD 410 may include multiple sets of one or more of the illustrated components for different wireless technologies supported by WD 410, such as, for example, GSM, WCDMA, LTE, NR, WiFi, WiMAX, or Bluetooth wireless technologies, just to mention a few. These wireless technologies may be integrated into the same or different chips or set of chips as other components within WD 410.

Antenna 411 may include one or more antennas or antenna arrays, configured to send and/or receive wireless signals, and is connected to interface 414. In certain alternative embodiments, antenna 411 may be separate from WD 410 and be connectable to WD 410 through an interface or port. Antenna 411, interface 414, and/or processing circuitry 620 may be configured to perform any receiving or transmitting operations described herein as being performed by a WD. Any information, data and/or signals may be received from a network node and/or another WD. In some embodiments, radio front end circuitry and/or antenna 411 may be considered an interface.

As illustrated, interface 414 comprises radio front end circuitry 412 and antenna 411. Radio front end circuitry 412 comprise one or more filters 418 and amplifiers 416. Radio front end circuitry 412 is connected to antenna 411 and processing circuitry 420, and is configured to condition signals communicated between antenna 411 and processing circuitry 620. Radio front end circuitry 412 may be coupled to or a part of antenna 411. In some embodiments, WD 410 may not include separate radio front end circuitry 412; rather, processing circuitry 420 may comprise radio front end circuitry and may be connected to antenna 411. Similarly, in some embodiments, some or all of RF transceiver circuitry 422 may be considered a part of interface 414. Radio front end circuitry 412 may receive digital data that is to be sent out to other network nodes or WDs via a wireless connection. Radio front end circuitry 412 may convert the digital data into a radio signal having the appropriate channel and bandwidth parameters using a combination of filters 418 and/or amplifiers 416. The radio signal may then be transmitted via antenna 411. Similarly, when receiving data, antenna 411 may collect radio signals which are then converted into digital data by radio front end circuitry 412. The digital data may be passed to processing circuitry 420. In other embodiments, the interface may comprise different components and/or different combinations of components.

Processing circuitry 420 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 410 components, such as device readable medium 430, WD 410 functionality. Such functionality may include providing any of the various wireless features or benefits discussed herein. For example, processing circuitry 420 may execute instructions stored in device readable medium 430 or in memory within processing circuitry 420 to provide the functionality disclosed herein.

As illustrated, processing circuitry 420 includes one or more of RF transceiver circuitry 422, baseband processing circuitry 424, and application processing circuitry 426. In other embodiments, the processing circuitry may comprise different components and/or different combinations of components. In certain embodiments processing circuitry 420 of WD 410 may comprise a SOC. In some embodiments, RF transceiver circuitry 422, baseband processing circuitry 424, and application processing circuitry 426 may be on separate chips or sets of chips. In alternative embodiments, part or all of baseband processing circuitry 424 and application processing circuitry 426 may be combined into one chip or set of chips, and RF transceiver circuitry 422 may be on a separate chip or set of chips. In still alternative embodiments, part or all of RF transceiver circuitry 422 and baseband processing circuitry 424 may be on the same chip or set of chips, and application processing circuitry 426 may be on a separate chip or set of chips. In yet other alternative embodiments, part or all of RF transceiver circuitry 422, baseband processing circuitry 424, and application processing circuitry 426 may be combined in the same chip or set of chips. In some embodiments, RF transceiver circuitry 422 may be a part of interface 414. RF transceiver circuitry 422 may condition RF signals for processing circuitry 420.

In certain embodiments, some or all of the functionality described herein as being performed by a WD may be provided by processing circuitry 420 executing instructions stored on device readable medium 430, which in certain embodiments may be a computer-readable storage medium. In alternative embodiments, some or all of the functionality may be provided by processing circuitry 420 without executing instructions stored on a separate or discrete device readable storage medium, such as in a hard-wired manner In any of those particular embodiments, whether executing instructions stored on a device readable storage medium or not, processing circuitry 420 can be configured to perform the described functionality. The benefits provided by such functionality are not limited to processing circuitry 420 alone or to other components of WD 410, but are enjoyed by WD 410 as a whole, and/or by end users and the wireless network generally.

Processing circuitry 420 may be configured to perform any determining, calculating, or similar operations (e.g., certain obtaining operations) described herein as being performed by a WD. These operations, as performed by processing circuitry 420, may include processing information obtained by processing circuitry 420 by, for example, converting the obtained information into other information, comparing the obtained information or converted information to information stored by WD 410, and/or performing one or more operations based on the obtained information or converted information, and as a result of said processing making a determination.

Device readable medium 430 may be operable to store a computer program, software, an application including one or more of logic, rules, code, tables, etc. and/or other instructions capable of being executed by processing circuitry 420. Device readable medium 430 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 420. In some embodiments, processing circuitry 420 and device readable medium 430 may be considered to be integrated.

User interface equipment 432 may provide components that allow for a human user to interact with WD 410. Such interaction may be of many forms, such as visual, audial, tactile, etc. User interface equipment 432 may be operable to produce output to the user and to allow the user to provide input to WD 410. The type of interaction may vary depending on the type of user interface equipment 432 installed in WD 410. For example, if WD 410 is a smart phone, the interaction may be via a touch screen; if WD 410 is a smart meter, the interaction may be through a screen that provides usage (e.g., the number of gallons used) or a speaker that provides an audible alert (e.g., if smoke is detected). User interface equipment 432 may include input interfaces, devices and circuits, and output interfaces, devices and circuits. User interface equipment 432 is configured to allow input of information into WD 410, and is connected to processing circuitry 420 to allow processing circuitry 420 to process the input information. User interface equipment 432 may include, for example, a microphone, a proximity or other sensor, keys/buttons, a touch display, one or more cameras, a USB port, or other input circuitry. User interface equipment 432 is also configured to allow output of information from WD 410, and to allow processing circuitry 420 to output information from WD 410. User interface equipment 432 may include, for example, a speaker, a display, vibrating circuitry, a USB port, a headphone interface, or other output circuitry. Using one or more input and output interfaces, devices, and circuits, of user interface equipment 432, WD 410 may communicate with end users and/or the wireless network, and allow them to benefit from the functionality described herein.

Auxiliary equipment 434 is operable to provide more specific functionality which may not be generally performed by WDs. This may comprise specialized sensors for doing measurements for various purposes, interfaces for additional types of communication such as wired communications etc. The inclusion and type of components of auxiliary equipment 434 may vary depending on the embodiment and/or scenario.

Power source 436 may, in some embodiments, be in the form of a battery or battery pack. Other types of power sources, such as an external power source (e.g., an electricity outlet), photovoltaic devices or power cells, may also be used. WD 410 may further comprise power circuitry 437 for delivering power from power source 436 to the various parts of WD 410 which need power from power source 436 to carry out any functionality described or indicated herein. Power circuitry 437 may in certain embodiments comprise power management circuitry. Power circuitry 437 may additionally or alternatively be operable to receive power from an external power source; in which case WD 410 may be connectable to the external power source (such as an electricity outlet) via input circuitry or an interface such as an electrical power cable. Power circuitry 437 may also in certain embodiments be operable to deliver power from an external power source to power source 436. This may be, for example, for the charging of power source 436. Power circuitry 437 may perform any formatting, converting, or other modification to the power from power source 636 to make the power suitable for the respective components of WD 410 to which power is supplied.

Radio Resources Used in a Wireless Network

The determination of synchronization signal (SS) block mapping pattern discussed herein above uses signaling and resources in a wireless network. FIG. 5A shows an exemplary signal transmission hierarchy in a wireless network. The exemplary signal transmission hierarchy includes the transmission unit of frame such as radio frame 502. A radio frame 502 takes ten milliseconds to transmit in one embodiment. The frame may contain a number of subframes such as subframe 504. In this example, the radio frame 502 contains ten subframes, each takes one millisecond. Each subframe may contain a number of slots. For example, a subframe may contain two slots. Each slot such as the slot at reference 506 may contain a number of symbols. In one example, a slot contains either 7 or 14 symbols. The symbol is an orthogonal frequency-division multiplexing (OFDM) symbol in one embodiment.

The frame—subframe—slot—symbol hierarchy is an example of time domain hierarchy. In the frequency domain (as illustrated at reference 532), each symbol may be transmitted over a number of subcarriers. A symbol may be transmitted using a number of resource block (RB), each of which may contain 12 subcarriers in one embodiment. In one embodiment, each subcarrier includes a bandwidth (e.g., 7.5 kHz or 15 kHz) for transmission. One subcarrier x one symbol may be referred to as a resource element (RE), which is the smallest unit of resource to be allocated for signal transmission in one embodiment.

The illustrated frame structure offers an example for signal transmission. In this frame structure or other frame structures, data and signaling transmission is performed at a lowest level of time unit (symbol level in this case), which is included in a time unit (slot level in this example) a level over the lowest level of time unit in one embodiment. Data and signaling for one transmission from a source network device to a destination network device often use the same position within the signal transmission hierarchy, e.g., the same symbol position in consecutive slots (e.g., symbol #2 of each slot) or subframes, or in alternating slots (e.g., symbol #2 in every other slot) or subframes.

FIG. 5B shows resource elements used for data and signaling transmission. The physical resources for transmission may be view as time and frequency grids as illustrated, where each resource element occupies a time period in the time domain and a frequency range in the frequency domain. Each OFDM symbol includes a cyclic prefix as illustrated at reference 552. Each OFDM symbol utilizes a number of resource elements. In this example, the sub-carrier spacing is 15k Hz, and the resource element (RE) 552 occupies an orthogonal frequency-division multiplexing (OFDM) subcarriers within an OFDM symbol. A network device may allocate some resource elements for a particular type of signaling. Such allocation may be specified through identifying the time period in the time domain and the frequency range in the frequency domain in a signal transmission hierarchy; or it may be specified through identifying specific resource elements within the signal transmission hierarchy.

For downlink control, a wireless network may use PDCCHs (physical downlink control channels) to transmit downlink control information (DCI), which provides downlink scheduling assignments and uplink scheduling grants. The PDCCHs are in general transmitted at the beginning of a slot and relate to data in the same or a later slot (for mini-slots PDCCH can also be transmitted within a regular slot). Different formats (sizes) of the PDCCHs are possible to handle different DCI payload sizes and different aggregation levels (i.e. different code rate for a given payload size). A UE is configured (implicitly and/or explicitly) to blindly monitor (or search) for a number of PDCCH candidates of different aggregation levels and DCI payload sizes. Upon detecting a valid DCI message (i.e. the decoding of a candidate is successful and the DCI contains a ID the UE is told to monitor) the UE follows the DCI (e.g. receives the corresponding downlink data or transmits in the uplink). The blind decoding process comes at a cost in complexity in the UE but is required to provide flexible scheduling and handling of different DCI payload sizes.

Different NR use-cases (e.g. MBB (mobile broadband), URLLC (ultra-reliable low latency communication)) require different control regions (e.g. time, frequency, numerologies etc.) & PDCCH configurations (e.g. operating points etc.) PDCCHs in NR are transmitted in configurable/dynamic control regions called control resource sets (CORESET) enabling variable use-cases. A CORESET is a subset of the downlink physical resource configured to carry control signaling. It is analogous to the control region in LTE but generalized in the sense that the set of physical resource blocks (PRBs) and the set of OFDM symbols in which it is located is configurable.

In one embodiment, CORESET configuration in frequency allocation is done in units of 6 RBs using NR DL resource allocation Type 0: bitmap of RB groups (RBGs). CORESET configuration in time spans of 1-3 consecutive OFDM symbols. For slot-based scheduling, the CORESET span at the beginning of a slot is at most 2 if demodulation reference signal (DMRS) is located in OFDM Symbol (OS) #2 and is at most 3 if DMRS is located in OS #3. A UE monitors one or more CORESETs. Multiple CORESETs can be overlapped in frequency and time for a UE.

User Equipment in Accordance with Some Embodiments

FIG. 6 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 600 may be any UE identified by the 3^{rd} Generation Partnership Project (3GPP), including a NB-IoT UE, a machine type communication (MTC) UE, and/or an enhanced MTC (eMTC) UE. UE 600, as illustrated in FIG. 6, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE 600 includes processing circuitry 601 that is operatively coupled to input/output interface 605, radio frequency (RF) interface 609, network connection interface 611, memory 615 including random access memory (RAM) 717, read-only memory (ROM) 619, and storage medium 621 or the like, communication subsystem 631, power source 613, and/or any other component, or any combination thereof. Storage medium 621 includes operating system 623, application program 625, and data 627. In other embodiments, storage medium 621 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry 601 may be configured to process computer instructions and data. Processing circuitry 601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 601 may include two central processing units (CPUs). Data may be information in a form suitable for use by a computer.

In the depicted embodiment, input/output interface 605 may be configured to provide a communication interface to an input device, output device, or input and output device. UE 600 may be configured to use an output device via input/output interface 605. An output device may use the same type of interface port as an input device. For example, a USB port may be used to provide input to and output from UE 600. The output device may be a speaker, a sound card, a video card, a display, a monitor, a printer, an actuator, an emitter, a smartcard, another output device, or any combination thereof. UE 600 may be configured to use an input device via input/output interface 605 to allow a user to capture information into UE 600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 609 may be configured to provide a communication interface to RF components such as a transmitter, a receiver, and an antenna. Network connection interface 611 may be configured to provide a communication interface to network 643a. Network 643a may encompass wired and/or wireless networks such as a local-area network (LAN), a wide-area network (WAN), a computer network, a wireless network, a telecommunications network, another like network or any combination thereof. For example, network 643a may comprise a Wi-Fi network. Network connection interface 611 may be configured to include a receiver and a transmitter interface used to communicate with one or more other devices over a communication network according to one or more communication protocols, such as Ethernet, TCP/IP, SONET, ATM, or the like. Network connection interface 611 may implement receiver and transmitter functionality appropriate to the communication network links (e.g., optical, electrical, and the like). The transmitter and receiver functions may share circuit components, software or firmware, or alternatively may be implemented separately.

RAM 617 may be configured to interface via bus 602 to processing circuitry 601 to provide storage or caching of data or computer instructions during the execution of software programs such as the operating system, application programs, and device drivers. ROM 619 may be configured to provide computer instructions or data to processing circuitry 601. For example, ROM 619 may be configured to store invariant low-level system code or data for basic system functions such as basic input and output (I/O), startup, or reception of keystrokes from a keyboard that are stored in a non-volatile memory. Storage medium 621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 621 may be configured to include operating system 623, application program 625 such as a web browser application, a widget or gadget engine or another application, and data file 627. Storage medium 621 may store, for use by UE 600, any of a variety of various operating systems or combinations of operating systems.

Storage medium 621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 621 may allow UE 600 to access computer-executable instructions, application programs or the like, stored on transitory or non-transitory memory media, to off-load data, or to upload data. An article of manufacture, such as one utilizing a communication system may be tangibly embodied in storage medium 621, which may comprise a device readable medium.

In FIG. 6, processing circuitry 601 may be configured to communicate with network 643b using communication subsystem 631. ‘Network 743a and network 643b may be the same network or networks or different network or networks. Communication subsystem 631 may be configured to include one or more transceivers used to communicate with network 643b. For example, communication subsystem 631 may be configured to include one or more transceivers used to communicate with one or more remote transceivers of another device capable of wireless communication such as another WD, UE, or base station of a radio access network (RAN) according to one or more communication protocols, such as IEEE 802.7, CDMA, WCDMA, GSM, LTE, UTRAN, WiMax, or the like. Each transceiver may include transmitter 633 and/or receiver 635 to implement transmitter or receiver functionality, respectively, appropriate to the RAN links (e.g., frequency allocations and the like). Further, transmitter 633 and receiver 635 of each transceiver may share circuit components, software or firmware, or alternatively may be implemented separately.

In the illustrated embodiment, the communication functions of communication subsystem 631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 631 may include cellular communication, Wi-Fi communication, Bluetooth communication, and GPS communication. Network 643b may encompass wired and/or wireless networks such as a local-area network (LAN), a wide-area network (WAN), a computer network, a wireless network, a telecommunications network, another like network or any combination thereof. For example, network 643b may be a cellular network, a Wi-Fi network, and/or a near-field network. Power source 613 may be configured to provide alternating current (AC) or direct current (DC) power to components of UE 600.

The features, benefits and/or functions described herein may be implemented in one of the components of UE 600 or partitioned across multiple components of UE 600. Further, the features, benefits, and/or functions described herein may be implemented in any combination of hardware, software or firmware. In one example, communication subsystem 631 may be configured to include any of the components described herein. Further, processing circuitry 601 may be configured to communicate with any of such components over bus 602. In another example, any of such components may be represented by program instructions stored in memory that when executed by processing circuitry 601 perform the corresponding functions described herein. In another example, the functionality of any of such components may be partitioned between processing circuitry 601 and communication subsystem 631. In another example, the non-computationally intensive functions of any of such components may be implemented in software or firmware and the computationally intensive functions may be implemented in hardware.

Virtualization Environment in Accordance with Some Embodiments

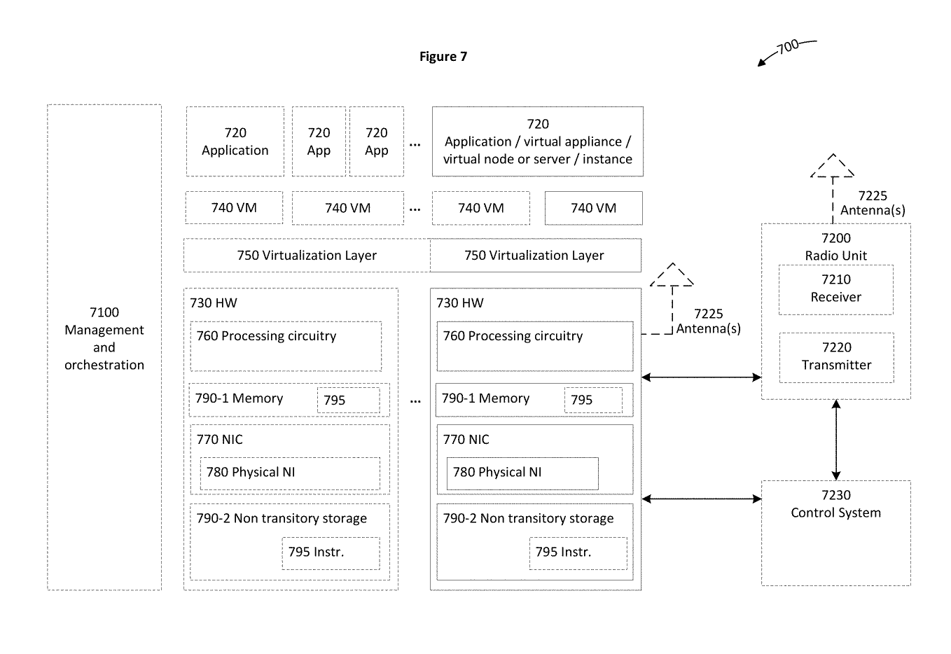

FIG. 7 is a schematic block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 700 hosted by one or more of hardware nodes 730. Further, in embodiments in which the virtual node is not a radio access node or does not require radio connectivity (e.g., a core network node), then the network node may be entirely virtualized.

The functions may be implemented by one or more applications 720 (which may alternatively be called software instances, virtual appliances, network functions, virtual nodes, virtual network functions, etc.) operative to implement some of the features, functions, and/or benefits of some of the embodiments disclosed herein. Applications 720 are run in virtualization environment 700 which provides hardware 730 comprising processing circuitry 760 and memory 790. Memory 790 contains instructions 795 executable by processing circuitry 760 whereby application 720 is operative to provide one or more of the features, benefits, and/or functions disclosed herein.

Virtualization environment 700, comprises general-purpose or special-purpose network hardware devices 730 comprising a set of one or more processors or processing circuitry 760, which may be commercial off-the-shelf (COTS) processors, dedicated Application Specific Integrated Circuits (ASICs), or any other type of processing circuitry including digital or analog hardware components or special purpose processors. Each hardware device may comprise memory 790-1 which may be non-persistent memory for temporarily storing instructions 795 or software executed by processing circuitry 760. Each hardware device may comprise one or more network interface controllers (NICs) 770, also known as network interface cards, which include physical network interface 780. Each hardware device may also include non-transitory, persistent, machine-readable storage media 790-2 having stored therein software 795 and/or instructions executable by processing circuitry 760. Software 795 may include any type of software including software for instantiating one or more virtualization layers 750 (also referred to as hypervisors), software to execute virtual machines 740 as well as software allowing it to execute functions, features and/or benefits described in relation with some embodiments described herein.

Virtual machines 740, comprise virtual processing, virtual memory, virtual networking or interface and virtual storage, and may be run by a corresponding virtualization layer 750 or hypervisor. Different embodiments of the instance of virtual appliance 720 may be implemented on one or more of virtual machines 740, and the implementations may be made in different ways.

During operation, processing circuitry 760 executes software 795 to instantiate the hypervisor or virtualization layer 750, which may sometimes be referred to as a virtual machine monitor (VMM). Virtualization layer 750 may present a virtual operating platform that appears like networking hardware to virtual machine 740.

As shown in FIG. 7, hardware 730 may be a standalone network node with generic or specific components. Hardware 730 may comprise antenna 7225 and may implement some functions via virtualization. Alternatively, hardware 730 may be part of a larger cluster of hardware (e.g. such as in a data center or customer premise equipment (CPE)) where many hardware nodes work together and are managed via management and orchestration (MANO) 7100, which, among others, oversees lifecycle management of applications 720.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 740 may be a software implementation of a physical machine that runs programs as if they were executing on a physical, non-virtualized machine. Each of virtual machines 740, and that part of hardware 730 that executes that virtual machine, be it hardware dedicated to that virtual machine and/or hardware shared by that virtual machine with others of the virtual machines 740, forms a separate virtual network elements (VNE).

Still in the context of NFV, Virtual Network Function (VNF) is responsible for handling specific network functions that run in one or more virtual machines 740 on top of hardware networking infrastructure 730 and corresponds to application 720 in FIG. 7.

In some embodiments, one or more radio units 7200 that each include one or more transmitters 7220 and one or more receivers 7210 may be coupled to one or more antennas 7225. Radio units 7200 may communicate directly with hardware nodes 730 via one or more appropriate network interfaces and may be used in combination with the virtual components to provide a virtual node with radio capabilities, such as a radio access node or a base station.

In some embodiments, some signaling can be effected with the use of control system 8230 which may alternatively be used for communication between the hardware nodes 730 and radio units 7200.

Telecommunication Network Connected Via an Intermediate Network to a Host Computer in Accordance with Some Embodiments

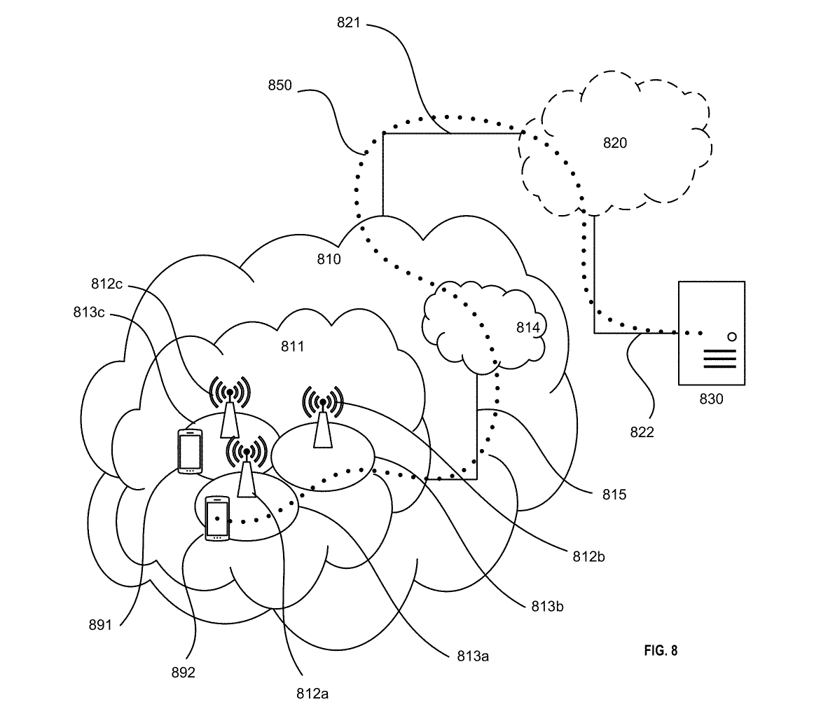

With reference to FIG. 8, in accordance with an embodiment, a communication system includes telecommunication network 810, such as a 3GPP-type cellular network, which comprises access network 811, such as a radio access network, and core network 814. Access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider, or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 8 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

Host Computer Communicating Via a Base Station with a User Equipment Over a Partially Wireless Connection in Accordance with Some Embodiments

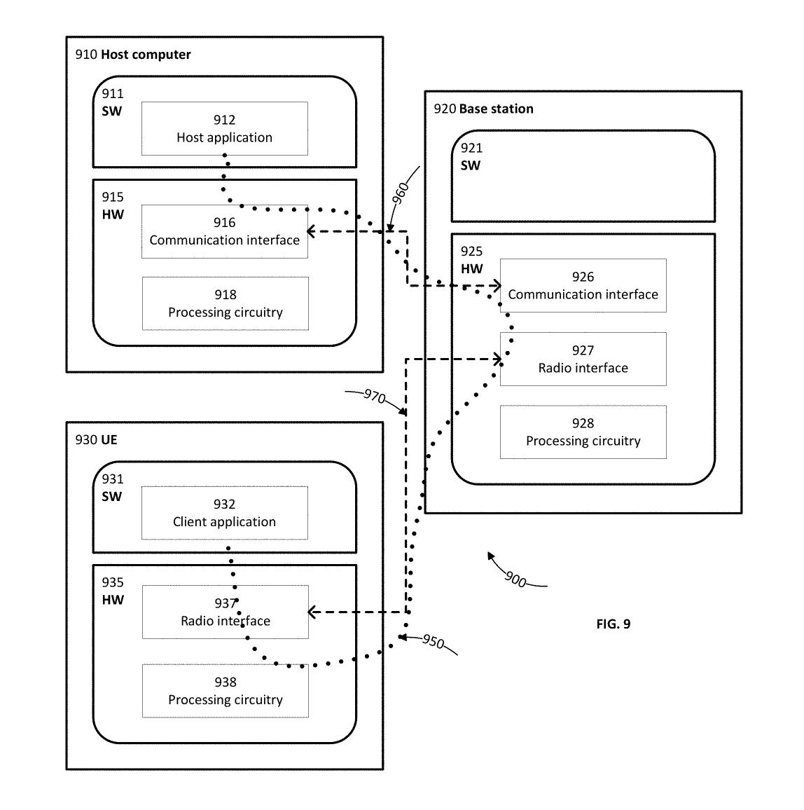

Example implementations, in accordance with an embodiment, of the UE, base station and host computer discussed in the preceding paragraphs will now be described with reference to FIG. 9. In communication system 900, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with UE 930 located in a coverage area (not shown in FIG. 9) served by base station 920. Communication interface 926 may be configured to facilitate connection 960 to host computer 910. Connection 960 may be direct or it may pass through a core network (not shown in FIG. 9) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. The hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 9 may be similar or identical to host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above, or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

Some of the embodiments contemplated herein above are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Embodiments

Group A Embodiments
#1. A method performed by a device for drying resources of a botnet that are connecting to the internet over a radio infrastructure, the method comprising:
   receiving signaling messages along with samples of the spurious traffic from a set or one or more radio base stations that are providing internet connectivity to end devices through radio-enabled customer premise equipment (radio-enabled CPE);
   determining, based on the samples, that there is a distributed denial of service attack (DDoS attack) occurring in which a set of one or more of the end devices is acting as bots in the botnet, and are thus are infected end devices; and
   instructing the set of radio base stations to deny the allocation of over-the-air resources to the set of one or more of the end devices.
#2. The method of the previous embodiment, wherein the determining is performed by baseband circuitry of the radio base stations.
#3. The method of any of the previous embodiments, wherein the signaling messages include parameters identifying one or more of the type of traffic and the number of packets received, and wherein the samples are packet headers.
Group B Embodiments
#4. A method performed by a radio base station for drying resources of a botnet that are connecting to the internet over a radio infrastructure, the method comprising:
   detecting spurious traffic from end devices being provided internet connectivity by the radio base through radio-enabled customer premise equipment (radio-enabled CPE) (radio-enabled CPE);
   sending signaling messages along with samples of the spurious traffic to another device that aggregates spurious traffic from other radio base stations and analyzes the spurious traffic to detect the occurrence of a distributed denial of service attack (DDoS attack) in which a set of one or more of the end devices is acting as bots in the botnet, and are thus are infected end devices;
   receiving, by the radio base station, instruction from the another device to deny the allocation of over-the-air resources to the set of one or more of the end devices.
#5. The method of the previous embodiment further comprising:
   the radio base station storing a set of one or more parameters identifying the set one or more end devices, wherein the parameters include one or more of radio layers identification parameters, IP addresses, and as correlations of these parameters.
#6. The method of any of the previous embodiments, further comprising:
   The radio base station consulting a home location register (HLR) database to gather more data about the set of one or more devices.
Group C Embodiments
#7. A device for drying resources of a botnet that are connecting to the internet over a radio infrastructure, the device comprising:
   processing circuitry configured to perform any of the steps of any of the Group A embodiments; and
   power supply circuitry configured to supply power to the device.
#8. A radio base station for drying resources of a botnet that are connecting to the internet over a radio infrastructure, the radio base station comprising:
   processing circuitry configured to perform any of the steps of any of the Group B embodiments;
   power supply circuitry configured to supply power to the wireless device.
#9. A communication system including a host computer comprising:
   processing circuitry configured to provide user data; and
   a communication interface configured to forward the user data to a cellular network for transmission to a user equipment (UE),
   wherein the cellular network comprises a radio base station having a radio interface and processing circuitry, the radio base station's processing circuitry configured to perform any of the steps of any of the Group B embodiments.
#10. The communication system of the pervious embodiment further including the radio base station.
#11. The communication system of the previous two embodiments, further including the UE, wherein the UE is configured to communicate with the radio base station.
#12. The communication system of the previous three embodiments, wherein:
   the processing circuitry of the host computer is configured to execute a host application, thereby providing the user data; and
   the UE comprises processing circuitry configured to execute a client application associated with the host application.
#13. A method implemented in a communication system including a host computer, a radio base station and a user equipment (UE), the method comprising:
   at the host computer, providing user data; and
   at the host computer, initiating a transmission carrying the user data to the UE via a cellular network comprising the radio base station, wherein the radio base station performs any of the steps of any of the Group B embodiments.
#14. The method of the previous embodiment, further comprising, at the radio base station, transmitting the user data.
#15. The method of the previous two embodiments, wherein the user data is provided at the host computer by executing a host application, the method further comprising, at the UE, executing a client application associated with the host application.
#16. A communication system including a host computer comprising:
   processing circuitry configured to provide user data; and
   a communication interface configured to forward user data to a cellular network for transmission to a user equipment (UE),
   wherein the UE comprises a radio interface and processing circuitry,
   a third device configured to perform any of the steps of any of the Group A embodiments.
#17. The communication system of the previous embodiment, wherein the cellular network further includes a radio base station configured to communicate with the UE.
#18. The communication system of the previous two embodiments, wherein:
   the processing circuitry of the host computer is configured to execute a host application, thereby providing the user data; and
   the UE's processing circuitry is configured to execute a client application associated with the host application.
#19. A method implemented in a communication system including a host computer, a base station and a user equipment (UE), the method comprising:
   at the host computer, providing user data; and
   at the host computer, initiating a transmission carrying the user data to the UE via a cellular network comprising the radio base station, wherein a third device performs any of the steps of any of the Group A embodiments.
#20. The method of the previous embodiment, further comprising at the UE, receiving the user data from the radio base station.
#21. A communication system including a host computer comprising:
   communication interface configured to receive user data originating from a transmission from a user equipment (UE) to a radio base station coupled to a third device,
   wherein the UE comprises a radio interface and processing circuitry, wherein the third device includes processing circuitry configured to perform any of the steps of any of the Group A embodiments.
#22. The communication system of the previous embodiment, further including the UE.
#23. The communication system of the previous two embodiments, further including the radio base station, wherein the radio base station comprises a radio interface configured to communicate with the UE and a communication interface configured to forward to the host computer the user data carried by a transmission from the UE to the radio base station.
#24. The communication system of the previous three embodiments, wherein:
   the processing circuitry of the host computer is configured to execute a host application; and
   the UE's processing circuitry is configured to execute a client application associated with the host application, thereby providing the user data.
#25. The communication system of the previous four embodiments, wherein:
   the processing circuitry of the host computer is configured to execute a host application, thereby providing request data; and
   the UE's processing circuitry is configured to execute a client application associated with the host application, thereby providing the user data in response to the request data.
#26. A method implemented in a communication system including a host computer, a radio base station and a user equipment (UE), the method comprising:
   at the host computer, receiving user data transmitted to the radio base station from the UE, wherein the radio base station is coupled to a third device that performs any of the steps of any of the Group A embodiments.
#27. The method of the previous embodiment, further comprising, at the UE, providing the user data to the radio base station.
#28. The method of the previous two embodiments, further comprising:
   at the UE, executing a client application, thereby providing the user data to be transmitted; and
   at the host computer, executing a host application associated with the client application.
#29. The method of the previous three embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
#30. A communication system including a host computer comprising a communication interface configured to receive user data originating from a transmission from a user equipment (UE) to a base station, wherein the radio base station comprises a radio interface and processing circuitry, the radio base station's processing circuitry configured to perform any of the steps of any of the Group B embodiments.
#31. The communication system of the previous embodiment further including the radio base station.
#32. The communication system of the previous two embodiments, further including the UE, wherein the UE is configured to communicate with the radio base station.
#33. The communication system of the previous three embodiments, wherein:
   the processing circuitry of the host computer is configured to execute a host application;
   the UE is configured to execute a client application associated with the host application, thereby providing the user data to be received by the host computer.
#34. A method implemented in a communication system including a host computer, a radio base station and a user equipment (UE), the method comprising:
   at the host computer, receiving, from the radio base station coupled to a third device, user data originating from a transmission which the base station has received from the UE, wherein the third device performs any of the steps of any of the Group A embodiments.
#35. The method of the previous embodiment, further comprising at the radio base station, receiving the user data from the UE.
#36. The method of the previous two embodiments, further comprising at the radio base station, initiating a transmission of the received user data to the host computer.

What is claimed is:

1. A method performed by an electronic device to resolve a distributed denial of service (DDoS) attack in a wireless network, the method comprising:
receiving signaling messages along with samples of spurious traffic sourced from one or more end devices, wherein the one or more end devices connect to the wireless network for internet connectivity;
determining, based the samples, that there is a DDoS attack occurring in which a set of one or more of the end devices is acting as bots in a botnet, and are thus are infected end devices; and
causing denial of radio resource allocation to the set of one or more of the infected end devices.

2. The method of claim 1, wherein the one or more end devices connect to a radio base station that comprises a baseband unit (BBU) and a remote radio head (RRH), one of which performs the determination of the DDoS attack.

3. The method of claim 2, wherein a distributed entity that is coupled to one or more BBUs performs the determination of the DDoS attack.

4. The method of claim 2, wherein causing the denial of radio resource allocation to the set of one or more of the end devices comprises instructing the radio base station to deny the radio resource allocation to the set of one or more of the end devices.

5. The method of claim 1, wherein identification information of the one or more end devices is provided to the electronic device.

6. The method of claim 5, wherein the identification information comprises one or more of a mobile station international subscriber directory number (MSISDN), a temporary MSISDN (TMSISDN), an International mobile subscriber identity (IMSI), an internet protocol (IP) address, a port number, or a media access control (MAC address).

7. The method of claim 1, wherein the determination of the DDoS attack comprises gathering data about the infected end devices from a home location register (HLR) database of the wireless network.

8. The method of claim 1, wherein the signaling messages include parameters identifying one or more of the type of traffic and the number of packets received, and wherein the samples are packet headers.

9. The method of claim 1, further comprising:
requesting the wireless network to deny access to the infected end devices by instructing a home subscriber server (HSS) or a mobility management entity (MME) to deny the access.

10. The method of claim 1, wherein the one or more end devices connect to a radio-enabled customer premise equipment (CPE), which connects to a software-defined network (SDN) controller coupled to a distributed entity, wherein the distributed entity receives the signaling messages along with the samples of the spurious traffic from the SDN controller and performs the determination of the DDoS attack.

11. An electronic device to be deployed in a wireless network, comprising:
a processor and computer-readable storage medium that provides instructions that, when executed by the processor, cause the electronic device to perform:
receiving signaling messages along with samples of spurious traffic sourced from one or more end devices, wherein the one or more end devices connect to the wireless network for internet connectivity;
determining, based the samples, that there is a DDoS attack occurring in which a set of one or more of the end devices is acting as bots in a botnet, and are thus are infected end devices; and
causing denial of radio resource allocation to the set of one or more of the infected end devices.

12. The electronic device of claim 11, wherein the electronic device is one of a baseband unit (BBU) and a remote radio head (RRH), and the BBU and RRH are within a radio base station to which the one or more end devices connect.

13. The electronic device of claim 12, wherein the electronic device is a distributed entity coupled to one or more BBUs.

14. The electronic device of claim 11, wherein the determination of the DDoS attack comprises gathering data about the infected end devices from a home location register (HLR) database of the wireless network.

15. The electronic device of claim 11, wherein the electronic device is to further perform:
requesting the wireless network to deny access to the infected end devices by instructing a home subscriber server (HSS) or a mobility management entity (MME) to deny the access.

16. A non-transitory computer-readable storage medium that provides instructions that, when executed by a processor of an electronic device, cause the electronic device to perform:
receiving signaling messages along with samples of spurious traffic sourced from one or more end devices, wherein the one or more end devices connect to the wireless network for internet connectivity;
determining, based the samples, that there is a DDoS attack occurring in which a set of one or more of the end devices is acting as bots in a botnet, and are thus are infected end devices; and
causing denial of radio resource allocation to the set of one or more of the infected end devices.

17. The non-transitory computer-readable storage medium of claim 16, wherein identification information of the one or more end devices is provided to the electronic device.

18. The non-transitory computer-readable storage medium of claim 17, wherein the identification information of the one or more end devices comprises one or more of a mobile station international subscriber directory number (MSISDN), a temporary MSISDN (TMSISDN), or an International mobile subscriber identity (IMSI), an internet protocol (IP) address, a port number, or a media access control (MAC address).

19. The non-transitory computer-readable storage medium of claim 16, wherein the determination of the DDoS attack comprises gathering data about the infected end devices from a home location register (HLR) database of a wireless network.

20. The non-transitory computer-readable storage medium of claim 16, wherein the one or more end devices connect to a radio-enabled customer premise equipment (CPE), which connects to a software-defined network (SDN) controller coupled to a distributed entity, wherein the distributed entity receives the signaling messages along with the samples of the spurious traffic from the SDN controller and performs the determination of the DDoS attack.
